(19) United States
(12) Patent Application Publication
(10) Pub. No.: US 2014/0270876 A1
(43) Pub. Date: Sep. 18, 2014

(54) FIXING MEMBER, FIXING DEVICE, AND IMAGE FORMING APPARATUS

(71) Applicants: Yasuyuki Yamashita, Shizuoka (JP); Yuka Aoyama, Kanagawa (JP); Shinji Nohsho, Tokyo (JP)

(72) Inventors: Yasuyuki Yamashita, Shizuoka (JP); Yuka Aoyama, Kanagawa (JP); Shinji Nohsho, Tokyo (JP)

(73) Assignee: RICOH COMPANY, LTD., Tokyo (JP)

(21) Appl. No.: 14/194,894

(22) Filed: Mar. 3, 2014

(30) Foreign Application Priority Data
Mar. 15, 2013 (JP) 2013-053094

(51) Int. Cl. G03G 15/20

(52) U.S. Cl. CPC G03G 15/2053
USPC 399/329; 399/333

(57) ABSTRACT

A fixing member to fix toner on a recording medium includes a heat-resistant elastic layer and a release layer. The release layer includes a particle layer. The particle layer includes heat-resistant fine particles arranged in a surface direction on a surface of the heat-resistant elastic layer.

### CROSS-REFERENCE TO RELATED APPLICATIONS

This patent application is based on and claims priority pursuant to 35 U.S.C. §119 to Japanese Patent Application No. 2013-053094, filed on Mar. 15, 2013, in the Japan Patent Office, the entire disclosure of which is hereby incorporated by reference herein.

### BACKGROUND

1. Technical Field

Embodiments of the present invention relate to a fixing member, a fixing device including the fixing member, and an image forming apparatus, such as a copier, a printer, or a facsimile, including the fixing device.

2. Description of the Related Art

Conventionally, an image forming apparatus employing an electrophotographic system, e.g. a copier, a printer, and a facsimile, generally includes a photoconductor drum which rotates, and a photosensitive layer of the photoconductor drum is uniformly charged and then exposed to a laser beam emitted from a laser scanning unit so as to form an electrostatic latent image thereon. The latent electrostatic image is developed with toner and then transferred onto transfer paper serving as a recording medium. Subsequently, the transfer paper is passed through fixing members such as a pair of heat fixing rollers where a toner image is thermally fixed.

In a full-color copier and laser printer, for example, toners of four colors, i.e. magenta (M), cyan (C), yellow (Y), and black (K), are used. When toner images developed with the color toners are thermally fixed, the four-color toners are mixed together in a melted state. Accordingly, the toners have a low melting point so that the toners can easily melt, and are mixed in a combined manner and in a melted state on a surface of the fixing member such as a fixing belt.

In the thermal fixing method, since a toner image fused onto a recording medium such as paper comes into contact with a fixing member, an outermost layer of the fixing member is formed of a material (e.g. fluorine resin) which is superior in release performance to a film thickness of 15 μm to 30 μm. However, the heat fixing roller makes direct contact with an image bearing surface of the recording medium, an image developing agent which constructs an image on the recording medium (hereinafter, referred to as “toner”) partially adheres and sticks to a surface of the heat fixing roller, and this tends to cause a so-called “offset phenomenon” in which the stuck toner is transferred onto the recording medium again as the roller rotates.

In view of this, as a method to prevent the offset phenomenon, a method for providing an offset prevention coating layer made of a highly releasable material (non-adhesive material) such as fluororesin, e.g., polytetrafluoroethylene resin (hereinafter, referred to as “PTFE”), or silicone rubber on an outer circumference of the heat fixing roller is employed conventionally, so that release performance (non-adhesiveness) of a surface layer of the heat fixing roller is improved.

However, for example, the fluororesin is a resin, which itself poses a problem of high material hardness.

If the material has a high degree of hardness, the material presents low followability to the irregularities of the paper fiber if, for example, the recording medium is paper when the toner image which is electrostatically formed is fixed thereon by heat and pressure. Therefore, an image with a high image quality cannot be obtained.

To solve this problem, a fixing member with an elastic member formed on a surface thereof is used.

When the elastic member is formed on the surface of the fixing member, the followability is improved by its elasticity, and a high image quality is provided even in a color image. However, this poses a problem in which a durability corresponding to that of the fluororesin cannot be provided, and wear resistance thereof is extremely poor. Further, when a scratch is caused on an outermost layer thereof by friction of the transfer paper, a separation claw for separating the transfer paper, or the like, the fixing member is scratched, and a shape of the scratch may be transferred to produce an abnormal image during a fixing process.

A composition obtained by mixing a large amount of fine particles of silica or fine particles of alumina with a silicone rubber composition purposed for improving the wear resistance is already publicly known.

However, such silicone rubber has a high degree of rubber hardness, and cannot provide sufficient elasticity for obtaining a high image quality. Hence, for example, in JP-H09-165515-A proposes a material having a reduced crosslink density to obtain a low degree of hardness of rubber.

However, in such a case, a reduce rubber strength may cause a failure, such as falling out of an inorganic filler, and sufficient wear resistance may not be obtained. Depending on conditions, the inorganic filler might function as an abrasion agent, thus accelerating wear of the rubber.

### BRIEF SUMMARY

In at least one embodiment of this disclosure, there is provided a fixing member to fix toner on a recording medium. The fixing member includes a heat-resistant elastic layer and a release layer. The release layer includes a particle layer. The particle layer includes heat-resistant fine particles arranged in a surface direction on a surface of the heat-resistant elastic layer.

In at least one embodiment of this disclosure, there provided a fixing device including the abode-described fixing member.

In at least one embodiment of this disclosure, there is provided an image forming apparatus including an electrostatic latent image carrier, an electrostatic latent image forming device, a developing device, a transfer device, and the above-described fixing device. The electrostatic latent image forming device forms an electrostatic latent image on the electrostatic latent image carrier. The developing device develops the electrostatic latent image with toner to form a visible image. The transfer device transfers the visible image onto a recording medium. The fixing device fixes, on the recording medium, the visible image transferred from the transfer device.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view of an image forming apparatus with a fixing device according to an embodiment of the present invention;

FIGS. 2A and 2B are schematic views of a layer structure of a fixing member according to an embodiment of the present invention;

FIG. 3 is a schematic view of a device for forming a release layer in the fixing member according to an embodiment of the present invention;

FIG. 4 is a schematic view of a particle embedded ratio of a particle layer of the fixing member according to an embodiment of the present invention; and

FIG. 5 is a schematic view of a degree of circularity SF1 of particles used in an embodiment of the present invention.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION OF EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the invention and all of the components or elements described in the embodiments of this disclosure are not necessarily indispensable to the present invention.

Referring now to the drawings, wherein like reference numerals designate identical or corresponding parts throughout the several views, embodiments of the present invention are described below.

(Fixing Member)

A fixing member according to at least one embodiment of the present invention has a heat-resistant elastic layer and a release layer that forms an outermost surface layer. Although the release layer is formed of a particle layer in which heat-resistant fine particles are arranged in a surface direction on a surface of the heat-resistant elastic layer, another layer, for example, a base material layer having a physical strength or a primer layer provided between individual layers, may be further provided as required.

Here, the fixing member refers to any one of multilayer structures having a structure provided with an elastic layer 202 and a release layer 201 formed on the elastic layer 202 as illustrated in FIG. 2A and a structure provided sequentially with a base material layer 203, an elastic layer (intermediate layer) 202 on the base material layer 203, and a release layer (outermost surface layer) 201 as illustrated in FIG. 2B. As obvious from these drawings, the release layer has the heat-resistant fine particles arranged on a surface of the heat-resistant elastic layer, and part of each of the particles protrudes from the surface of the elastic layer. Hereinafter, each layer of the fixing member according to an embodiment of the present invention is described in details.

—Base Material Layer—

As described above, the base material layer may be separately provided under the release layer and the elastic layer, the base material layer involves no particular restrictions in shape, structure, thickness, material, size, and the like thereof, and therefore it can be arbitrarily selected from among the publicly known members according to the specifications or the like of the fixing device to be installed in the image forming apparatus.

No restriction is particularly placed on the shape thereof, and the shape may be, for example, a belt-like shape, a cylindrical shape, or the like. No restriction is particularly placed on the structure thereof, and the structure can be arbitrarily selected, and it may be a single-layer structure or a multilayer structure.

No restriction is particularly placed on the material thereof, and the material can be arbitrarily selected. However, it is preferably to use the material having heat-resistant properties, and the material may be, for example, a resin, a metal, or the like.

No restriction is particularly placed on the resin thereof, and the resin can be arbitrarily selected, and may be, for example, polyimide, polyamideimide, polyetheretherketone (PEEK), polyethersulfone (PES), polyphenylene sulfide (PPS), fluororesin, or the like.

In addition, the base material layer can also be formed of an elastic member.

Examples of the elastic member include natural rubber, styrene butadiene rubber (SBR), butyl rubber, chloroprene rubber, nitrile rubber, acrylic rubber, urethane rubber, silicone rubber, fluorosilicone rubber, fluorine rubber, fluorocarbon siloxane rubber, and liquid fluorine elastomers, and the like. Among these, silicone rubber, fluorosilicone rubber, fluorine rubber, fluorocarbon siloxane rubber, liquid fluorine elastomers, and the like are preferable in terms of heat resistance. Further, magnetic conductive particles may be dispersed in these resin materials for use so that it can generate heat.

Specifically, the magnetic conductive particles are dispersed in a resin material (e.g. monomer coating solution having high viscosity) in a varnish-like state by using a dispersing device such as a roll mill, a sand mill or a centrifugal defoaming device. The resultant is adjusted by a solvent so as to have an appropriate viscosity and made as a coating liquid, and this is coated onto a mold to form it into a desired thickness.

Examples of the metal include nickel, iron, chromium, alloys of such metals, or a material that produces heat by itself such as a magnetic conductive material. When the magnetic conductive particles or materials described above are used, it is possible to obtain a desired Curie point by adjusting an additive amount of each of the materials and process conditions, and, by forming a heat-generating layer of a magnetic conductive material whose Curie point is in the vicinity of a fixation temperature of the fixing member, the heat-generating layer can be heated without the temperature being excessively increased by electromagnetic induction.

It is preferable, in terms of heat capacity and strength, that the base material layer has a thickness between 30 μm and 500 μm, more preferably, between 50 μm and 150 μm. In the case where a fixing belt uses a metal material, it is preferable, in view of the flexibility of the fixing belt, that the base material layer has a thickness of 100 μm or less.

—Elastic Layer—

As a material for forming the heat-resistant elastic layer, no particular restriction is placed thereon as long as it is a heat-resistant elastic member, and although the material can be arbitrarily selected according to the purpose, heat-resistant rubber is preferable. Examples of the heat-resistant rubber include natural rubber, SBR, butyl rubber, chloroprene rubber, nitrile rubber, acrylic rubber, urethane rubber, silicone rubber, fluorosilicone rubber, fluorine rubber, liquid fluorine elastomers, and the like.

Among these, elastic rubber whose main-chain component contains siloxane bonds are preferable in terms of heat resistance, particularly, silicone rubber, fluorosilicone rubber, fluorine rubber, fluorocarbon siloxane rubber, and liquid fluorine elastomers are more preferable, and silicone rubber and fluorosilicone rubber are particularly preferable in terms of heat resistance and wettability to the release agent.

The method for forming the elastic layer is not particularly restricted and may be arbitrarily selected according to the purpose. Examples thereof include a blade coating method, roll coating method, and die coating method. The thickness of the elastic layer is not particularly restricted and may be arbitrarily selected according to the purpose, but is preferably in a range between 50 μm to 500 μm. If the thickness of the elastic layer is smaller than 50 μm, the irregularities of the transfer paper cannot be followed, and therefore there may be some cases where an excellent image cannot be obtained. If the thickness exceeds 500 μm, it takes a time to accumulate an amount of heat required for fixing, and therefore the convenience may be drastically decreased.

—Release Layer—

The release layer that is the outermost layer is formed of a particle layer in which heat-resistant fine particles are arranged in a surface direction on a surface of the heat-resistant elastic layer.

It is preferable that the heat-resistant fine particles have a melting point or a thermal softening point of 200° C. or higher.

Using the heat-resistant fine particles makes it possible to form an image of a high image quality as described above, and, at the same time, prevent a member from being damaged by overheating of the fixing member in the case where the fixing unit is heated to an abnormally high temperature when a regular image forming process can not be completed by an accidental trouble. Here, there are substances which do not have a clear melting point among polymeric materials which do not have a crystal structure. In such a case, fluidity of the substance is increased, and can show a thermal softening point as a thermal temperature at which the material deforms with an application of an external force.

No restriction is particularly placed on the heat-resistant fine particles, and the heat-resistant fine particles can be arbitrarily selected according to the purpose. However, it is preferable, in terms of heat resistance properties to use, for example, glass, fluororesin, titanium dioxide, calcium carbonate, manganese oxide, aluminum oxide, or polyimide. No restriction is particularly placed on the shape of the heat-resistant fine particles, but a spherical shape is preferable.

FIG. 5 is a schematic view of determination of a shape factor SF1.

The shape factor SF1 refers to a numerical value indicating a degree of sphericity of a spherical substance as illustrated in FIG. 5, and is obtained in the following way. Specifically, the shadow of a spherical substance is cast on a two-dimensional plane to form an ellipsoidal projection image. Subsequently, the maximum length MXLNG of the ellipsoidal projection image is squared. The resultant value is divided by an image area AREA, and then multiplied by 100π/4. To state it differently, the shape factor SF1 is calculated by the following equation (I).

SF1={(MXLNG)2/AREA}×(100π/4) (1)

In the case where the heat-resistant fine particles having a spherical shape is used in this embodiment, if the shape factor SF1 of the fine particles is 100 to 150, it is easy to arrange the heat-resistant fine particles having a spherical shape in a surface direction to form a particle layer, thus obtaining a preferable effect.

Further, as the particle diameter thereof, a volume average particle diameter is 0.1 μm to 10.0 μm, and, preferably, 0.1 μm to 5.0 μm. If it is 5.0 μm or larger, or further, even 8 μm or larger, a sufficient effect is provided. In addition, it is preferable that the distribution of the particle diameters be in a sharp shape.

If the particle diameter is 0.1 μm or smaller, a sufficient effect of release performance by the particles may not be obtained. By contrast, if the particle diameter is 10.0 μm or larger, surface roughness thereof increases, and surface roughness of a fixed image increases, resulting in a loss of glossiness.

At the same time, gaps between the particles increase, which causes a failure such as reduced release performance.

The heat-resistance fine particles are preferably arranged on a surface of a heat-resistant elastic member be monodispersed, particle by particle, but not a form of conglomerate of a plurality of particles. When the particles are not monodispersed, a structure in which the particles overlap one another in a height direction is easily formed when the release layer is formed, and the heat-resistant fine particles cannot be arranged in the surface direction. FIGS. 2A and 2B illustrate an example using heat-resistant fine particles having a spherical shape, and the fine particles having a spherical shape are arranged in a surface direction. In this way, it is preferable that the particles be formed as a single layer structure without being stacked on top of one another.

Next, a method of forming the release layer is described.

FIG. 3 illustrates one example of forming the particle layer of the heat-resistant fine particles using a release layer formation device. The formation device includes a cylindrical mold 31, a powder coating device 35, and a pressing member 33. A coating liquid used for base material layer or the like supplied from a coating liquid supply device is coated onto an outer circumference of a mold while the cylindrical mold is rotated, or a heat-resistant elastic layer coating liquid 32 is directly coated without using the coating liquid used for the base material layer. Thereafter, the heat-resistant fine particles having a spherical shape supplied from the powder coating device 35 are uniformly dredged on a surface while the mold is rotated, and the spherical particles dredged on the surface are pressed against at a constant pressure by the pressing member 33. The pressing member 33 embeds the particles in the resin layer and at the same time removes surplus particles.

Particularly, in the case where the monodispersed fine particles having a spherical shape are used, it is possible to form a single layer of the particle layer in which the particles are not stacked on top of one another but uniformly aligned with such a simple process involving only a smoothing process by such a pressing member.

After forming a uniform particle layer as described above, for example, the mold is rotated and heated at a predetermined temperature and for a predetermined period, and the fine particles are fixed to the heat-resistant elastic layer so as to form the release layer formed of a particle layer in which the heat-resistant fine particles are arranged in a surface direction on a surface of the heat-resistant elastic layer. Thereafter, the finished product is removed from the mold, and a fixing belt having the release layer formed on a surface of the heat-resistant elastic layer can be obtained.

In addition, a cylindrical heat fixing roller base material is used instead of the mold; the heat-resistant elastic layer coating liquid is coated on an outer circumference of the base material as in the case of the foregoing; thereafter, the heat-resistant fine particles are uniformly smeared thereon and smoothed uniformly by the pressing member; and then heat is applied. With only this arrangement, the heat fixing roller having the heat-resistant elastic layer and the release layer arranged on the base material can be obtained. In this embodiment, it is preferable to have a structure in which the heat-resistant fine particles are embedded in the heat-resistant elastic layer. An embedded ratio thereof is represented by an embedded depth with respect to an entire length in an embedded direction of the embedded heat-resistant fine particles, and it is preferable that the embedded ratio be more than 50% and 90% or less which is less than 100%.

FIG. 4 is a schematic view of a particle embedded ratio of the fine resin particles having a spherical shape, and is an enlarged view of a part of the release layer of the fixing member illustrated in FIG. 2A or FIG. 2B.

This has a structure in which the resin particles having a spherical shape which constitute the release layer are partially embedded into a lower layer formed of an elastic layer or a base material layer. It is assumed that a diameter of the resin particles having a spherical shape from a deepest portion to an outermost portion is h0, and a distance from the deepest portion to a surface of the lower layer, i.e., a depth of embedment into the lower layer, is h1. In this case, the embedded ratio is expressed by h1/h0×100(%). Specifically, the embedded ratio that satisfies 50(%)<h1/h0×100<100(%) is preferable. If this is 50% or less, separation of particles tends to be caused when an electrophotographic device is used over a long period, which results in deteriorated durability.

By contrast, if this is 100%, effectiveness of an anti-offset property (release performance) exerted by the particles is reduced, which is not preferable.

Adjustment of the embedded ratio of the fine particles into a resin layer can also be performed by another method. For example, by adjusting a pressing force of the pressing member (43), it can be easily achieved.

For example, in the case of the heat-resistant fine particles having a spherical shape, the relation of 50%<the embedded ratio<90% can be achieved relatively easily by adjusting the pressing force in a range between 1 mN/cm and 1000 mN/cm.

(Fixing Device)

A fixing device according to an embodiment of the present invention includes the fixing member according to at least one embodiment of the present invention, and also includes other members as required.

Examples of specific forms of the fixing member according to embodiments of the present invention are the fixing belt, the heat fixing roller, and the like as described above, and the release layer formed of the particle layer in which the heat-resistant fine particles are arranged in a surface direction is provided on a surface of the elastic layer thereof. Examples of a fixing device using such a fixing belt and a heat fixing roller are indicated by reference numerals 5 and 112 in FIG. 1.

In the fixing device 112 using a fixing belt according to an embodiment of the present invention, a fixing belt 113 is stretched and supported by a heat fixing roller 114 and a heating roller 116 incorporating therein a heater, a pressure roller 115 is provided in a position opposite thereto with the fixing belt interposed therebetween, and the pressure roller and the belt are in pressurized contact with each other with a predetermined pressing force.

A recording medium on which a toner image is transferred passes between a fixing belt and a pressure roller, and toner on the recording medium is fixed to the recording medium by the pressure and softening of toner caused by heating of the fixing belt based on the heating roller.

By contrast, in a fixing device 5 using a heat fixing roller according to an embodiment of the present invention, a pressure roller is provided in a position opposing the heat fixing roller. The heat fixing roller has a heater such as a halogen lamp provided in a hollow portion of a cored bar along a center line of rotation, and the pressure roller and the heat fixing roller are in pressurized contact with each other with a predetermined pressing force. The recording medium on which the toner image has been transferred passes between the heat fixing roller and the pressure roller, and thereby the toner image on the recording medium is fixed to the recording medium by the pressure and softening of toner caused by heating.

In addition, in the fixing device according to an embodiment of the present invention, a temperature sensor, a controller for controlling the heater based on a temperature detected by the temperature sensor, or a separation claw for separating the recording medium from the fixing member after fixing may be provided.

When the fixing device according to an embodiment of the present invention is used as a fixing unit of an image forming apparatus, image formation of a high image quality can be performed, and, even if the fixing unit is heated to an abnormally hot temperature, the member is not damaged by overheating of the fixing member, so that high quality image formation and high reliability are provided.

(Image Forming Apparatus)

The image forming apparatus according to an embodiment of the present invention includes at least an electrostatic latent image carrier, an electrostatic latent image forming device, a developing device, a transfer device, and a fixing device according to an embodiment of the present invention; and further includes other devices arbitrarily selected as required, for example, a charge eliminating device, a cleaning device, a recycling device, a control device, and the like.

Hereinafter, the image forming apparatus according to an embodiment of the present invention is described in details.

—Electrostatic Latent Image Carrier—

As an electrostatic latent image carrier (hereinafter, may be referred to as “electrophotographic photoconductor”, “photoconductor”, or “image carrier”), a material, shape, structure, size, and the like thereof are not particularly restricted, and can be arbitrarily selected from among publicly known materials. The shape thereof is preferably a drum shape, and examples of the material thereof include an inorganic photoconductor such as amorphous silicon and selenium, and an organic photoconductor such as polysilane and phthalopolymethine.

Among these, preference is given to amorphous silicon and the like in view of a long lifetime.

—Latent Image Forming Device—

The latent image forming device includes, for example, at least a charger for uniformly charging a surface of the electrostatic latent image carrier, and an exposing unit for exposing the surface of the electrostatic latent image carrier in an image pattern.

The charging can be performed, for example, by using the charger to thereby apply a voltage onto the surface of the electrostatic latent image carrier.

No particular restrictions are placed on the charger, and it can be arbitrarily selected according to the purpose thereof. Examples thereof include a publicly known contact charger equipped with a conductive or semiconductive roll, brush, film, rubber blade, or the like, and a non-contact charger utilizing corona discharge such as corotron, scorotron, or the like.

The exposure can be performed, for example, by exposing the surface of the electrostatic latent image carrier in an image pattern, using the exposing unit.

No particular restrictions are placed on the exposing unit as long as it can perform exposure of an image pattern to be formed on the surface of the electrostatic latent image carrier which has been charged by the charger, and it can be arbitrarily selected according to the purpose thereof. Examples thereof include various types of exposing units such as a copier optical system, a rod lens array system, a laser optical system, and a liquid crystal shutter optical system.

In an embodiment of the present invention, a back surface lighting method may be employed in which exposure is performed in an image pattern from a back surface side of the electrostatic latent image carrier.

—Developing Device—

No particular restrictions are placed on the developing device as long as it can perform development using toner or developer, and it can be arbitrarily selected from among the publicly known ones. Preferably, examples thereof include a developing device incorporating at least a developing unit that accommodates therein the toner or the developer and is capable of attaching, either in a contact or non-contact manner, the toner or the developer to the latent image.

The developing unit may be of a dry developing type or a wet developing type, and may be a single-color developing unit or a multi-color developing unit. Preferably, examples thereof include a developing unit incorporating an agitator for agitating with friction and charging the toner or the developer, a rotatable magnet roller, and the like.

In the developing unit, for example, the toner and the carrier are mixed and agitated together, the toner is charged by friction during such a process, and the toner and the carrier are held, in a napping state, on a surface of the magnet roller which is rotating to thereby form a magnetic brush.

Since the magnet roller is placed in the vicinity of the electrostatic latent image carrier (photoconductor), part of the toner which constitutes the magnetic brush formed on the surface of the magnet roller moves onto a surface of the electrostatic latent image carrier (photoconductor) by electric suction.

As a result of this, the latent image is developed with the toner, and a visible image composed of the toner is formed on the surface of the electrostatic latent image carrier (photoconductor).

The developer accommodated in the developing unit is the developer including the toner. However, the developer may be a mono-component developer or a two-component developer.

—Transfer Device—

As the transfer device, it is preferable that the transfer device be in a structure having a primary transfer device for transferring a visible image onto an intermediate transfer member to form a composite transferred image, and a secondary transfer device for transferring the composite transferred image onto a recording medium. No particular restrictions are placed on the intermediate transfer member, and it can be arbitrarily selected from among the publicly known recording media according to the purpose thereof. Preferably, examples thereof include a transfer belt and the like.

It is preferable that the transfer device (the primary transfer device and the secondary transfer device) includes at least a transfer unit that charges and thereby separates the visible image formed on the electrostatic latent image carrier (photoconductor) toward the recording medium.

One or more than one devices may be provided as the transfer device. Examples of the transfer unit include a corona transfer unit utilizing corona discharge, a transfer belt, a transfer roller, a pressure transfer roller, an adhesion transfer unit, and the like. No particular restrictions are placed on the recording medium, and it can be arbitrarily selected from among the publicly known ones (recording paper).

—Charge Eliminating Device—

No particular restrictions are placed on the charge eliminating device as long as it can apply a charge eliminating bias to the electrostatic latent image carrier, and it can be arbitrarily selected from among the publicly known charge eliminating units. Preferably, examples thereof include a charge eliminating lamp and the like.

—Cleaning Device—

No particular restrictions are placed on the cleaning device as long as it can remove the electrophotographic toner remaining on the electrostatic latent image carrier, and it can be arbitrarily selected from among the publicly known cleaners. Preferably, examples thereof include a magnetic brush cleaner, an electrostatic brush cleaner, a magnetic roller cleaner, a blade cleaner, a brush cleaner, a web cleaner, and the like.

—Recycling Device—

No particular restrictions are placed on the recycling device, and examples thereof include a publicly known conveying device and the like.

—Control Device—

No particular restrictions are placed on the control device as long as it can control motion of each of the devices, and it can be arbitrarily selected according to the purpose thereof. Preferably, examples thereof include devices such as a sequencer and a computer.

—Fixing Device—

The fixing device is a device for fixing the toner image which has been transferred onto the recording medium. Fixing of the toner image may be performed for toner of each color every time it is transferred onto the recording medium, or may be performed simultaneously at once while images of individual colors are stacked together.

As the fixing device, the image forming apparatus according to an embodiment of the present invention has at least a fixing device including the fixing member according to the above-described embodiment of the present invention.

FIG. 1 is a schematic view of an image forming apparatus according to an embodiment of the present invention having a configuration with a photoconductor drum 101, an image forming system thereof, and a fixing device 5 according to an embodiment of the present invention.

An image forming process of the image forming apparatus according to an embodiment of the present disclosure is arranged in the following manner. A photosensitive layer of the photoconductor drum 101 which is rotating is uniformly charged using a charging roller 102; thereafter, exposure is performed by a laser beam 103 from a laser scanning unit; an electrostatic latent image formed thereby on the photoconductor drum 101 is developed with toner to form a toner image; the toner image is transferred onto a recording medium (recording paper) 107; and the recording medium (recording paper) 107 is further fed through the fixing device 5 to thereby heat and pressurize the toner image so that the toner image is fixed onto the recording medium (recording paper) 107.

In FIG. 1, reference numeral 104 represents a developing roller, reference numeral 105 represents a power pack (power supply), reference numeral 106 represents a transfer roller, reference numeral 108 represents a cleaning device, and reference numeral 109 represents a surface electrometer.

The fixing device 5 uses a heat fixing roller 110 as the fixing member according to the above-described embodiment of the present invention.

In such a heat fixing roller 110, a heater such as a halogen lamp is placed in a hollow portion of a cored bar along a center line of rotation, and the heat fixing roller 110 is heated from inside by radiation heat thereof.

Further, in the fixing device 5, a pressure roller 111 is provided in a position opposing the heat fixing roller 110, and the heat fixing roller 110 and the pressure roller 111 are in pressurized contact with each other with a predetermined pressing force. The recording paper 107 is allowed to pass between the heat fixing roller 110 and the pressure roller 111, thereby the toner image on the recording paper 107 is softened by heat applied by the heat fixing roller 110, and pressurized between the pressure roller 111 and the heat fixing roller 110 so that the toner image is fixed onto the recording paper 107.

In addition, a fixing device 112 provided with a fixing belt as a fixing member according to an embodiment of the present invention can also be used as the fixing device of the image forming apparatus. In the fixing device 112 using the fixing belt, a fixing belt 113 is stretched and supported by a heat fixing roller 114 and a heating roller 116 incorporating therein a heater, a pressure roller 115 is provided in a position opposite thereto with the fixing belt interposed therebetween, and the pressure roller and the belt are in pressurized contact with each other with a predetermined pressing force. As described above, the recording medium on which the toner image is transferred passes between the fixing belt and the pressure roller, and the toner on the recording medium is fixed to the recording medium by the pressure and softening of toner caused by heating of the fixing belt based on the heating roller.

Since the image forming apparatus employs the fixing device according to the above-described embodiment of the present invention with improved durability and reliability, image formation of a high image quality can be performed, and, even if the fixing unit is heated to an abnormally hot temperature, the member is not damaged by overheating of the fixing member. Since the fixing device provides such a high image quality and a high reliability, it is suitable for a copiers a facsimile, a laser beam printer, and the like of an electrophotographic system.

### EXAMPLES

Next, examples according to embodiments of the present invention are described below. It is to be noted that the embodiments of the present are not to the following examples.

### Example 1

A silicone primer (Primer No. 4 manufactured by Shin-Etsu Chemical Co., Ltd.) layer was spray-coated on a base member with a cylindrical shape having a length of 320 mm and a thickness of 50 μm (made of polyimide resin) and dried, thereafter fluorosilicone (X36-420U having a rubber hardness of 40 Hs (Shore A hardness, corresponding to Vickers hardness of about 280 Hy), manufactured by Shin-Etsu Chemical Co., Ltd) was applied onto the silicone primer layer by blade coating, so that an elastic layer was coated.

Alumina particles having an average particle diameter of 3 μm (melting point of 2072° C., manufactured by Nippon Steel & Sumikin Materials Co., Ltd.) were used as the fine particles having a spherical shape. A release layer formed of a particle layer in which the particles were arranged in a single layer in a surface direction as illustrated in FIG. 2A was formed using a device illustrated in FIG. 3. A polyurethane rubber blade was pressed against it at a pressing force of 100 mN/cm to scratch off any surplus.

Heating was performed at a temperature of 150° C. for 10 minutes, and thereby the particles are fixed in the elastic layer. As a result, the release layer formed of the particle layer in which the particles as illustrated in FIG. 2A were arranged in a single layer in a surface direction on the elastic layer having a thickness of 200 μm was formed.

A fixing member 1 produced as described above was fitted to a fixing device of MPC3000, a copier manufactured by Ricoh Company, Ltd., 10 sheets with a solid toner image were output, and initial glossiness (followability to the irregularities) was evaluated on the 10th sheet in a manner described below. Also, an image with ruled lines was output, and an anti-offset property (release performance) was evaluated as described below. Used as test paper was Sable-X80.

Glossiness of Output Image and Anti-Offset Property Evaluation

The evaluation of the glossiness (followability to the irregularities) and the evaluation of the anti-offset property (release performance) were determined based on criteria indicated in Table 1.

—Glossiness (Followability to Irregularities) Evaluation—

A surface thereof was measured using a glossmeter (PG-1, at an angle of 60°, manufactured by NIPPON DENSHOKU INDUSTRIES CO., LTD.).

—Anti-offset Property (Release Performance) Evaluation—

An image surface of the image with ruled lines was evaluated by visually ranking it, and judgment of acceptance was carried out.

TABLE 1

| | | | Rank Judgment |
|---|---|---|---|
| | | Acceptance | Criteria (Ranked by |
| | | Rank | 4 steps, maximum |
| Items | Contents | Levels | evaluation is 4) |
| Glossiness | Achievement rate | 3 or higher | 1: Less than 10% |
| (irregularities | of glossiness | | 2: 10% or higher and |
| followability) | criterion | | lower than 50% |
| evaluation | (initial state) | | 3: 50% or higher |
| | | | 4: 100% achievement |
| Anti-offset | Ranking evaluation | 3 or higher | 1: Considerable peeling |
| property | of abnormal images | | of image or print stains |
| (release | such as peeling of | | 2: Abnormal image |
| performance) | image by offset and | | with peeling of |
| evaluation | retransfer of image | | image or print stains |
| | (print stains) | | 3: Allowable level, |
| | | | although peeling of |
| | | | image or print stains |
| | | | are noticed |
| | | | 4: None |

Evaluation on presence or absence of damage to a surface layer after forced stop In addition, similarly, while 100 sheets carrying the solid toner image were continuously output from the fixing device of MPC3000, a copier manufactured by Ricoh Company, Ltd., the copier was forcibly stopped immediately before the 95th sheet passed through the fixing device. The image was output 10 minutes thereafter, and presence or absence of an abnormal image, and presence or absence of abnormality of a surface of the fixing member by visual inspection were determined.

Evaluation of Arrangement of Particles in the Release Layer

Whether the particles of the release layer were monodispersed and arranged in a surface direction was observed by a scanning electron microscope (SEM) and judged.

### Example 2

A fixing member 2 was obtained by replacing the fine particles with a spherical shape in Example 1 with calcium carbonate particles having an average particle diameter of 8 μm (melting point of 825° C., manufactured by NEWLIME CO., LTD.) while the others remained the same, and the evaluation described above was conducted thereon.

### Example 3

A fixing member 3 was obtained by replacing the fine particles with a spherical shape in Example 1 with titania particles having an average particle diameter of 3 μm (melting point of 1843° C.) while the others remained the same, and the evaluation described above was conducted thereon.

### Example 4

A fixing member 4 was obtained by replacing the fine particles with a spherical shape in Example 1 with manganese oxide particles having an average particle diameter of 10 μm (melting point of 535° C.) while the others remained the same, and the evaluation described above was conducted thereon.

### Example 5

A fixing member 5 was obtained by replacing the fine particles with a spherical shape in Example 1 with polyimide resin (PI) particles having an average particle diameter of 10 μm (UIP-S, no melting point, thermal decomposition temperature of 550° C. or higher, manufactured by Ube Industries, Ltd.) while the others remained the same, and the evaluation described above was conducted thereon.

### Example 6

A fixing member 6 was obtained by replacing the fine particles with a spherical shape in Example 1 with glass particles having an average particle diameter of 5 μm (EMB-10, thermal softening temperature of 500° C., manufactured by Potters-Ballotini Co., Ltd.) while the others remained the same, and the evaluation described above was conducted thereon.

### Example 7

A fixing member 7 was obtained by replacing the fine particles with a spherical shape in Example 1 with PFA resin particles having an average particle diameter of 3.0 μm (MP-102, thermal softening temperature of 260° C., manufactured by Du Pont-Mitsui Fluorochemicals Company, Ltd.) while the others remained the same, and the evaluation described above was conducted thereon.

### Comparative Example 1

A fixing member 11 was obtained by coating a silicone (X34-387, having a rubber hardness of 41 Hs (Shore A hardness), manufactured by Shin-Etsu Chemical Co., Ltd.) to a thickness of 200 μm by blade coating on a base member with a cylindrical shape having a length of 320 mm and a thickness of 50 μm (made of polyimide resin), which was followed by heating at a temperature of 150° C. for 30 minutes and then secondary vulcanization at a temperature of 200° C. for 4 hours, and the evaluation described above was conducted thereon.

### Comparative Example 2

Instead of forming the particle layer in Example 1, the following release layer was formed.

A primer (PR-990CL, manufactured by Du Pont-Mitsui Fluorochemicals Co., Ltd.) was spray-coated to a thickness of 4 μm, and then dried at a temperature of 150° C. for 30 minutes.

Thereafter, mixed dispersion was obtained by mixing together, on a one-to-one basis, PEA (PFA-950HP Plus, manufactured by Du Pont-Mitsui Fluorochemicals Co., Ltd.) having an average particle diameter of 10 μm by MFR (measurement standards of JIS K 7210) of 2 [g/10 min] at a temperature of 372° C. and a load of 5 kgf, and PFA (PFA-945HP Plus, manufactured by Du Pont-Mitsui Fluorochemicals Co., Ltd.) having an average particle diameter of 0.1 μm by MFR (measurement standards of JIS K 7210) of 7 [g/10 min] at a temperature of 372° C. and a load of 5 kgf. Then, the mixed dispersion was spray-coated to a thickness of 30 μm. Then, a release layer was formed by firing at a temperature of 340° C. for 30 minutes (melting the PFA particles), was used as the fixing member 12, and subjected to the evaluation described above.

### Comparative Example 3

A fixing member 13 was obtained by replacing the fine particles with a spherical shape in Example 1 with polyethylene (melting point of 130° C.) having an average particle diameter of 17 μm, while the others remained the same, and the evaluation described above was conducted thereon.

Table 2 below indicates the results of evaluation judgments of the examples and the comparative examples.

TABLE 2

| | | | | | Presence or |
|---|---|---|---|---|---|
| | | | | | absence of |
| | | Average | | | surface layer |
| | | particle | | Anti- | damage after |
| | | diameter | Glossi- | offset | abnormal |
| | Release layer | (μm %) | ness | property | stop |
| Example 1 | Alumina | 8 | 4 | 4 | Absent |
| | particles | | | | |
| Example 2 | Calcium | 8 | 4 | 4 | Absent |
| | carbonate | | | | |
| Example 3 | Titanium | 3 | 4 | 4 | Absent |
| | dioxide | | | | |
| | particles | | | | |
| Example 4 | Manganese | 10 | 4 | 3 | Absent |
| | oxide | | | | |
| | particles | | | | |
| Example 5 | PI particles | 10 | 3 | 3 | Absent |
| Example 6 | Glass particles | 5 | 3 | 3 | Absent |
| Example 7 | PFA particles | 3 | 4 | 4 | Absent |
| Comparative | None | — | 2 | 1 | Absent |
| example 1 | | | | | |
| Comparative | PFA | — | 2 | 4 | Absent |
| example 2 | | | | | |
| Comparative | Polyethylene | 17 | 3 | 3 | Present |
| example 3 | | | | | |

As described above, Examples 1 to 7 according to embodiments of the present invention were excellent in the followability and the release performance. In addition, even in the case of abnormal stop during image forming process, no damage was caused by heating in the fixing member, and a subsequent normal image output was possible. By contrast, Comparative Examples 1 to 3 differing from the embodiments of the present invention were inferior in any of the followability and the release performance. Alternatively, after abnormal stop during image forming process, normal image output was impossible. Specifically, streaks in a horizontal band shape were present in the output image. When the fixing member was observed, the surface layer particles were melted, and the particle arrangement shape was not held. For this reason, the abnormal image was caused in the fixed image.

As describe above, a fixing member according to at least one embodiment of the present invention has a release layer including a particle layer in which heat-resistant fine particles are arranged in a surface direction on a surface of the heat-resistant elastic layer, has high followability to the irregularities of the recording medium, e.g., irregularities of paper fiber of the recording paper, improves glossiness by this, reduces abnormal images caused by an offset phenomenon due to reduction of sticking residue of molten toner by the release layer formed of a particle layer arranged as above, and thereby can form an image having a high image quality. Further, the fixing member according to at least one embodiment of the present invention has high thermal resistance, and can prevent damage to the fixing member caused by overheating also in a case in which the fixing member is heated to an abnormally high temperature.

In addition, according to a fixing device having the fixing member according to at least one embodiment of the present invention, it is possible to provide an image forming apparatus that forms an image with a high image quality and has a high reliability, and the image forming apparatus incorporating the fixing device according to at least one embodiment of the present invention can produce an image with a high image quality and has a high reliability.

The present invention has been described above with reference to specific exemplary embodiments. Note that the present invention is not limited to the details of the embodiments described above, but various modifications and enhancements are possible without departing from the spirit and scope of the invention. It is therefore to be understood that the present invention may be practiced otherwise than as specifically described herein.

For example, elements and/or features of different illustrative exemplary embodiments may be combined with each other and/or substituted for each other within the scope of the present invention.

What is claimed is:

1. A fixing member to fix toner on a recording medium, the fixing member comprising:
a heat-resistant elastic layer; and
a release layer including a particle layer,
wherein the particle layer includes heat-resistant fine particles arranged in a surface direction on a surface of the heat-resistant elastic layer.

2. The fixing member according to claim 1,
wherein the heat-resistant fine particles has a melting point or a thermal softening point of 200° C. or higher.

3. The fixing member according to claim 1,
wherein the heat-resistant fine particles are spherical.

4. The fixing member according to claim 1,
wherein the heat-resistant fine particles include glass, titanium dioxide, calcium carbonate, manganese oxide, aluminum oxide, polyimide resin, or fluororesin.

5. The fixing member according to claim 1,
wherein the heat-resistant elastic layer includes silicone rubber.

6. The fixing member according to claim 1,
wherein the fixing member is a fixing roller.

7. The fixing member according to claim 1,
wherein the fixing member is a seamless fixing belt.

8. A fixing device comprising the fixing member according to claim 1.

9. An image forming apparatus, comprising:
an electrostatic latent image carrier;
an electrostatic latent image forming device to form an electrostatic latent image on the electrostatic latent image carrier,
a developing device to develop the electrostatic latent image with toner to form a visible image;
a transfer device to transfer the visible image onto a recording medium; and
the fixing device according to claim 8 to fix, on the recording medium, the visible image transferred from the transfer device.
